(19) United States
(12) Patent Application Publication
(10) Pub. No.: US 2002/0058734 A1
(43) Pub. Date: May 16, 2002

(54) Asphalt emulsion

(76) Inventor: C. Wayne Harlan, Albuquerque, NM (US)

Correspondence Address: JSG Enterprises, Inc., d/b/a Georges Construction Company, 6934 Fourth Street, N.W., Albuquerque, NM, 87107, US

(21) Appl. No.: 09/778,317

(22) Filed: Feb. 6, 2001

Related U.S. Application Data
(63) Continuation-in-part of application No. 09/654,382, filed on Sep. 1, 2000.
Application No. 09/654,382 is a continuation-in-part of application No. PCT/US00/24388, filed on Sep. 5, 2000.

(51) Int. Cl. C08L 95/00; C08K 3/20

(52) U.S. Cl. 524/59; 524/60; 524/270

(57) ABSTRACT

An asphalt emulsion and method and apparatus of making the same.

### CROSS-REFERENCE TO RELATED APPLICATIONS

This application is a continuation-in-part application of U.S. patent application Ser. No. 09/654,382, entitled “Polymer-Modified Asphalt Emulsion,” to C. Wayne Harlan, filed on Sep. 1, 2000, and International Patent Application Number PCT/US00/24388, entitled “Polymer-Modified Asphalt Emulsion,” to C. Wayne Harlan, filed on Sep. 5, 2000, and the specifications thereof are incorporated herein by reference.

### BACKGROUND OF THE INVENTION

1. Field of the Invention (Technical Field)

The present invention relates to asphalt emulsions, and a method and apparatus to make and use the asphalt emulsions.

2. Background Art

Note that the following discussion refers to a number of publications by author(s) and year of publication, and that due to recent publication dates certain publications are not to be considered as prior art vis-a-vis the present invention. Discussion of such publications herein is given for more complete background and is not to be construed as an admission that such publications are prior art for patentability determination purposes. The patents cited are for all purposes herein incorporated by reference.

U.S. Pat. No. 6,107,374, entitled “Asphalt modified with olefin/vinylidene aromatic monomer interpolymers,” to Stevens, et al., issued Aug. 22, 2000, discloses a blend comprising 80% to 99% bitumen and interpolymers or comparative polymeric material, which are mixed using a high shear blender. In one example, a crosslinking component, e.g., sulfur, is then added followed by low shear mixing.

U.S. Pat. No. 5,973,037, entitled “Styrene ethylene butylene styrene (SEBS) copolymer rubber modified asphalt mixture,” to Fields, issued Oct. 26, 1999, discloses a process and composition for SEBS block copolymer modified asphalt mixtures. Powdered and pelletized SEBS is added to oxidized or unoxidized asphalt flux in a high-shear process.

U.S. Pat. No. 5,019,610, entitled “Process for the production of polymer-modified asphalts and asphalts emulsions,” to Stiz and Chatterjee, issued May 28, 1991 ('610 Patent), discloses a composition comprising from about 1% to about 50% by weight of a blend, the blend comprising from about 10 weight percent to 75 weight percent of a thermoplastic rubber polymer and from about 90 weight percent to 25 weight percent of a fatty dialkyl amide, and from about 99% to about 50% by weight of asphalt cement. According to the '610 Patent, it is preferred that the polymer be dissolved in the fatty dialkyl amide; however, it is also recognized that the addition of fatty dialkyl amide alone to asphalt serves to facilitate dissolution of polymer added independently of the fatty dialkyl amide. Low shear blending, e.g., hand/paddle mixing, is shown as a suitable method for mixing a polymer/fatty dialkyl amide with asphalt; however, when incorporating the polymer/fatty dialkyl amide into a cationic asphalt emulsion, blending is preferably achieved with a high shear colloid mill or homogenizer to obtain the desired emulsion. Thus, a suitable low shear method of incorporating a polymer into a cationic or anionic asphalt emulsion is not disclosed.

U.S. Pat. No. 5,443,632, entitled “Cationic aqueous bituminous emulsion-aggregate slurries,” to Schilling, issued Aug. 22, 1995 ('632 Patent), discloses use of a cationic bitumen emulsifier wherein the emulsifier is formed through the reaction of polyamines with certain fatty acids and rosins, and a quaternizing agent such as 2,3-epoxy-propyl-trimethyl ammonium chloride or 3-chloro-2-hydroxy propyl-trimethyl ammonium chloride. High shear mixing is used in forming the cationic bitumen emulsion. According to the '632 Patent, an organic additive-polymer latex may also be employed to strengthen the matrix wherein the organic additive is preferably added to the emulsion-aggregate slurry.

U.S. Pat. No. 3,423,221, entitled “Cationic bituminous emulsions for use in slurry seal treatments,” to Borgfeldt, issued Jan. 21,1969 ('221 Patent), discloses a reaction product pine wood resin acid and tetraethylene pentamine. According to the '221 Patent, the pine wood resin (sold under the mark VINSOL®, Hercules, Inc., Wilmington, Del.) is heated to 233° C. (451° F.) and the pentamine is heated to 93° C. (199° F.), next the pentamine is added to the resin with stirring. The reaction product is dissolved in water acidulated with hydrochloric acid. The hydrochloride salt is then used to emulsify asphalt in a conventional way, i.e., with a colloid mixer. According to the '221 Patent, 0.2% to 2% of emulsifier is added to 50% to 75% asphalt and the balance to 100% is water. The '221 Patent further states, “by contrast, a number of similar type salts of the reaction products of tall oil acids and aliphatic polyamines . . . have been found unsatisfactory for the preparation of emulsions of bitumen in water suitable for slurry seal work. Apparently, despite the presence of abietic acid in tall oil acid mixtures, a different mechanism of film stabilization takes place when employing tall oil acid-amine reaction products as emulsifiers for bitumen, precluding formation of a satisfactory product.”

### SUMMARY OF THE INVENTION (DISCLOSURE OF THE INVENTION)

The present invention comprises a composition, a method of making the same and a mixer apparatus. In one embodiment, the invention comprises a composition comprising bitumen and products obtained by reacting a resin with an amine. This embodiment optionally further comprises a polymer, wherein the polymer comprises at least approximately 3% of the composition by weight. Of course, a mixture of polymers is also within the scope of this embodiment. In this embodiment, the polymer optionally comprises styrene, for example, but not limited to a polymer comprising SBS. According to this embodiment, resin optionally comprises a rosin ester, for example, but not limited to, a pentaerythritol ester of rosin. Of course, resins comprising a plurality of rosin groups bound to at least one moiety through an ester linkage capable of forming a rosin acid (and/or rosin amide) and an alcohol group (on the at least one moiety) through disruption of the ester bond are within the scope of the present invention. Examples of such resins include, but are not limited to, dimer resin esters and others disclosed and/or described herein and equivalents thereof. In further accord with this embodiment, reaction products optionally comprise amides and/or alcohol, which include polyols.

In another embodiment, the present invention comprises a composition comprising bitumen, polymer, and products obtained by reacting a rosin ester with an amine, wherein the products comprise an alcohol and an amide. In this embodiment, the composition optionally comprises an emulsion, for example, but not limited to, a cationic, anionic, and/or nonionic emulsion.

In yet another embodiment, the present invention comprises a method of incorporating polymer into a bitumen emulsion comprising the steps of: combining bitumen, polymer, resin and amine to form a pre-mix; heating the pre-mix to a temperature sufficient to react the resin and the amine to form reaction products; and mixing the reacted pre-mix with a bitumen emulsion. In this embodiment, the resin optionally comprises a rosin ester, for example, but not limited to, a pentaerythritol ester of rosin and the polymer optionally comprises styrene, for example, but not limited to, SBS. Further, the reaction products optionally comprise an alcohol, for example, but not limited to, a polyol. The emulsion of this embodiment optionally comprises an emulsion selected from the group consisting of cationic, nonionic, and anionic emulsions. In further accord with this embodiment, the mixing step optionally comprises low shear mixing, as opposed to, for example, high shear mixing as commonly used in forming bitumen emulsions. Commonly used devices for high shear mixing of bitumen emulsions include colloid mills. Low shear operation of colloid mills may present a suitable mixing option and is thus within the scope of the present invention.

Another method embodiment of the present invention comprises a method of reducing the viscosity of a composition comprising bitumen and polymer, the method comprising the steps of: adding a resin and an amine to the composition; and reacting the resin and the amine to form reaction products, the reaction products comprising a viscosity reducer wherein the viscosity reducer optionally comprises an alcohol, for example, but not limited to, a polyol.

In yet another composition embodiment, the present invention comprises a composition comprising bitumen, polymer and products obtained by reacting a resin with an amine, wherein low shear mixing of the bitumen, polymer and products forms a stable bitumen emulsion. Stable includes, but is not limited to, emulsions that do not exhibit any significant phase separation after storage for several weeks at ambient temperature. In this embodiment, the polymer optionally comprises styrene, for example, but not limited to, SBS, and the resin optionally comprises a rosin ester, for example, but not limited to, a pentaerythritol ester of rosin. In further accord with this embodiment, the products optionally comprise an alcohol, for example, but not limited to, a polyol, for example, but not limited to, pentaerythritol.

A primary object of the present invention is to incorporate polymers into bitumen emulsions.

A primary advantage of the present invention is ease of incorporating polymers into bitumen emulsions.

Other objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated into and form a part of the specification, illustrate several embodiments of the present invention and, together with the description, serve to explain the principles of the invention. The drawings are only for the purpose of illustrating a preferred embodiment of the invention and are not to be construed as limiting the invention. In the drawings:

FIG. 1 is a diagram of one of the outer stirrer blades of the mechanical stirring apparatus of the invention; and

FIG. 2 is a component diagram of the mechanical stirring apparatus.

### DESCRIPTION OF THE PREFERRED EMBODIMENTS (BEST MODES FOR CARRYING OUT THE INVENTION)

In general, the compositions and methods of the present invention are useful for incorporating polymers into asphalt emulsions. In particular, the compositions, methods, and apparatus of the present invention are useful for incorporating polymers using low shear mixing techniques. The use of low shear mixing techniques saves energy and more importantly helps to preserve polymer chain length.

The present invention comprises a composition and a method of making the same. In one embodiment, the composition comprises polymer, bitumen, resin, and amine wherein the composition is heated and mixed. According to such an embodiment, the resin and amine react to form a resin amide. When the resin is supplied in the form of an ester, at least one ester bond is broken through amide formation. The particular reaction is also useful for release of a viscosity modifier or rheological property modifier and of particular usefulness are rheological property modifiers that reduce the viscosity of a bitumen mixture, i.e., viscosity reducers. For example, a reaction mixture comprising one pentaerythritol ester of rosin and four amines is capable of forming four rosin amides and pentaerythritol, which is a polyol and a rheological property modifier capable of reducing and/or favorably modifying the viscosity of a bitumen mixture. In general, a viscosity modifier, or rhelogical property modifier, comprises, for example, but not limited to, an alcohol, for example, a polyol. A further advantage is realized when the chosen resin is more chemically stable and/or easier to handle during processing. For example, rosin esters, such as, but not limited to, pentaerythritol ester of rosin, are generally more stable and easier to handle and process than free rosin acid.

In an alternative embodiment, the composition comprises polymer, bitumen and resin wherein the composition is heated and mixed using, for example, a mixer apparatus according to an embodiment of the present invention.

According to one embodiment, the composition of the present invention optionally comprises a pre-mix for incorporating polymer into asphalt, preferably a cationic asphalt emulsion and optionally an anionic asphalt emulsion. In this embodiment, the polymer passes through the water phase of the emulsion to enter the oil (predominantly asphalt) phase. The present invention also comprises a mixing process wherein a low shear mixer is used. Use of a low shear mixer is advantageous in that polymer chains are not subjected to detrimental high shear.

The following terms: bitumen (asphalt), amine, resin, polymer, and emulsion, are described in more detail below.

Bitumen

The “bitumen” in the emulsion or pre-mix may be derived from domestic or foreign crude oil; and it also includes bitumen, natural asphalt, petroleum oil, paving grade oil residue, plastic residue from coal tar distillation, petroleum pitch, asphalt cements diluted with solvents (cutback asphalt), semi-blown asphalt, petroleum tar, pitch, solvent-deasphalting asphalt, heavy oil, and a mixture of two or more kinds thereof.

Bitumen Emulsions

A bitumen or asphalt emulsion is a substantially homogeneous mixture of asphalt droplets suspended in a continuous water phase. In general, it can be used without the aid of heat or solvents. Emulsions can be pumped, stored and applied at much cooler temperatures than other asphalt and are often referred to as “cold applied” materials. Emulsions are traditionally created through a process wherein molten asphalt and treated water are mixed in a colloid mill, which is a high-shear mixing device specially designed for such a purpose. The colloid mill divides the asphalt into droplet sizes of approximately 0.001 inch to approximately 0.005 inch (0.025 to 0.125 mm).

The type of asphalt and the type of emulsifying agent used in treating the water are specific to the grade of emulsion being produced. Asphalt emulsions can be divided into three categories: anionic, cationic and nonionic. This grading system can be further divided into how quickly the emulsion sets or reverts to asphalt cement. Standard setting designations are RS, MS, SS and QS, which designate rapid, medium, slow and quick set emulsion grades. Other designations include “A” for anionic and “C” for cationic, e.g., CRS is a rapid set cationic grade. Commercially available emulsion grades include CRS-2, HFRS-2, RS-2, CRS-2P and HFRS-2P, some of which are polymer modified. There are numerous emulsions available for commercial use, which are within the scope of various embodiments of the present invention.

Amines

As used herein, the term “amine” includes polyamines. Tallow fatty acids, soya fatty acids, oleic fatty acids, and coconut fatty acids are suitable sources of fatty amines to be used in the invention composition. Fatty amines derived from, for example, petroleum based fatty acids or natural oils and fats (such as tallow, soya, oleic, tall oil, coconut, palm, vegetable, or fish) are within the scope of the present invention. Specific fatty amines which are suitable for use in formulating emulsifying and/or pre-mix compositions of the present invention include, but are not limited to, the following: tallow amine, tallow diamine, soya diamine, tall oil diamine, tallow triamine, tallow tetramine, oleyl diamine, coco diamine, linear C₈-C₁₈ petroleum-derived diamine, branched C₈ -C₁₈ petroleum-derived diamine, linear C₁₂-C₁₈ alkylether diamine, branched C₂-C₁₈ alkylether diamine, and combinations thereof. Suitable C₁₂-C₁₈ alkylether diamines may be produced from fatty alcohols via the addition of acrylonitrile and hydrogenation.

The term “amine” also includes a fatty diamine. The fatty diamines include mono- or dialkyl, symmetrical or asymmetrical ethylenediamines, propanediamines (1,2, or 1,3), and polyamine analogs of the above. Suitable commercial fatty polyamines are N-coco-1,3-diaminopropane, N-soya-1,3-diaminopropane, N-tallow-1,3-diaminopropane, and N-oleyl-1,3-diaminopropane. Some of these fatty polyamines are available from AKZO-NOBEL Chemicals, Inc. (Chicago, Ill.), under the mark DUOMEEN®). For example, DUOMEEN®) TD fatty polyamine comprises N-tallowalkyl-1,3-diaminopropane (RNH(CH₂)₃NH₂, where R is a tallowalkyl group, e.g., primarily composed of C₁₆ and C₁₈ chains). This material is a paste at 25° C. and has a melting point of approximately 44° C. and an amine number of approximately 348. Other DUOM EEN® products include N,N,N′-trimethyl-N′-tallowalkyl-1,3-diaminoproane (DUOM EEN® TTM); N-cocoalkyl-1,3-diaminopropane (DUOMEEN® C); N-tallowalkyl-1,3-diaminopropane dioleate (DUOMEEN® TDO); and Tris(2-hydroxyethyl)-N-tallowalkyl-1,3-diamoinopropane (ETHODUOMEEN® T/12). Quaternary salt equivalents are also available and within the scope of the present invention, some of which are sold by AKZO-NOBEL under the marks ARQUAD®, DUOQUAD® and ETHOQUAD®.

Resins

As used herein, the term “resin” encompasses natural resins. Natural resins include but are not limited to shellac, copals from various sources, e.g., Congo, Manila, etc.; amber, dammar, dead dammar, rosin (colophony), gum rosin, wood rosin, tall oil rosin, burgundy pitch, gurjun balsam, Canada balsam, sandarac, mastic, accroides, benzoin, elemi, gamboge, gum thus, venice turpentine, bordeaux turpentine, abietic acid, pimaric acid, etc.

Resin derivatives are also within the scope of the present invention and include natural resin derivatives, which include, but are not limited to, heat decomposition products of resins which contain a hydroaromatic nucleus; modifications of resins wherein the carbon structure of the abietyl nucleus is retained, including but not limited to: abietyl amine, dehydroabietyl amine, abietyl alcohol, zinc abietate, hydrogenated rosin, dehydroabietic acid, disproportioned rosin, rosin esters, ester gum (i.e., triglyceride of rosin), polymerized ester gum, hydrogenated ester gum, oxidized ester gum, etc.; and other modified resins; for example, aceto- and butyro-copal, copal ester, etc.

Rosin, also known as colophony, generally comprises a hard, brittle, translucent, usually amber-colored resin, which, for example, is left after distilling off volatile oil from the oleoresin obtained from species of Pinus. Varieties of rosin comprise, for example, gum rosin, wood rosin, and tall oil rosin (“tall” is the Swedish word for pine). Gum rosin is commonly the residue obtained after the distillation of turpentine from the oleoresin tapped from living pine trees. Wood rosin is commonly obtained by extracting pine stumps with naphtha or other suitable solvents and distilling off the volatile fraction. Tall oil rosin is commonly a co-product of the fractionation of tall oil, which in turn is a by-product of the wood pulping process.

In general, rosin comprises approximately 90% resin acids and 10% neutral matter. The resin acids ordinarily comprise diterpene resin acids of the abietic (abietic, neoabietic, palustric, and dehydroabietic) and pimaric types (pimaric, isopimaric, and sandaracopimaric). In general, of the resin acids, approximately 90% are isomeric with abietic acid (C₁₉H₂₉COOH) while the other 10% commonly comprises a mixture of dihydroabietic acid and dehydroabietic acid. See, e.g., The Merck Index, 12 ed., 1996. Most of the resin acids comprise a phenanthrene nucleus. While rosin is ordinarily presumed to be primarily abietic acid, as used herein, rosin may comprise a primary acid component that is not an abietic acid.

According to the present invention, rosins comprise, but are not limited to, vacuum distilled rosin, hydrogenated rosin, disproportionated rosin, modified rosin, polymerized rosin, dimeric rosin acids, deodorized glycerol ester of rosin, stabilized glycerol ester of rosin, glycerol ester of gum rosin, glycerol ester of hydrogenated rosin, glycerol ester of polymerized rosin, pentaerythritol ester of rosin, pentaerythritol ester of hydrogenated rosin, pentaerythritol ester of polymerized rosin, pentaerythritol ester of dimerized rosin, glycerol ester of maleic rosin, pentaerythritol ester of maleic rosin, glycerol ester of fumaric modified rosin, modified diethylene glycol ester of rosin, diethylene glycol ester of rosin, triethylene glycol ester of rosin, triethylene glycol ester of hydrogenated rosin, methyl ester of rosin, methyl ester of hydrogenated rosin, Ca/Zn resinate, modified metallic resinate, phenolic modified resin, terpene phenolic resin, beta pinene terpene resin, alpha pinene terpene resin, and polyterpene resin. Use of rosins comprising rosin esters, dimer rosins, rosins comprising terpenes and tree rosins and their derivatives are described in more detail below. In one embodiment, a polymerized cyclic terpene is used, (for example, but not limited to, polymerized d-limonene) in conjunction with another rosin. In general, such terpenes are useful with acrylic polymers, such as, EVA. One source of polymerized d-limonene is the Florida Chemical Company, Inc. (Winter Haven, Fla.). In general, terpene polymers can be produced by polymerization and/or copolymerization of terpene hydrocarbons such as the monocyclic, and bicyclic monoterpenes and their mixtures, including allo-ocimene, carene, isomerized pinene, pinene, dipentene, terpinene, terinolene, limonene, turpentine, a terpene cut or fraction, and various other terpenes. As discussed below, terpenes are polymerizable with other rosins as well.

U.S. Pat. No. 5,902,389, entitled “Rosin-based resin ink vehicles,” to Jordan, assigned to Arizona Chemical Company (Panama City, Fla.), issued May 11, 1999, discloses acid catalyzed rosin esters and phenolic modified rosin esters. Also disclosed are rosin esters made with an acid catalyst and a polyhydric alcohol or polyol such as pentaerythritol, glycerin, dipentaerythritol, tripentaerythritol, trimethylol ethane, trimethylol propane, ethylene glycol, polyethylene glycol, 1,3-propanediol, 1,4-butanediol, 1,5-pentanediol, 1,6-hexanediol, trimethylene glycol, propylene glycol, neopentyl glycol and the like. The use of such rosins is within the scope of the present invention. Use of polymerized and/or dimerized rosins alone or in the form of rosin esters are also within the scope of the present invention.

Rosin esters include, but are not limited to, a pentaerythritol ester of rosin such as SYLVATAC®) RE100 stabilized rosin ester available from Arizona Chemical Company (Panama City, Fla.) in, for example, a flaked form. Arizona Chemical recommends the SYLVATAC® RE100 stabilized rosin ester for use in adhesives, including ethylene vinyl acetate (EVA), styrene-butadiene-styrene (SBS), styrene-isoprene-styrene (SIS) and other hot melt adhesives, due to its excellent stability and low volatility. The SYLVATAC®) RE100 stabilized rosin ester is soluble in aromatic and aliphatic hydrocarbon solvents, esters, ketones and chlorinated solvents. The SYLVATAC® RE100 stabilized rosin ester is compatible with SBR, natural rubber, butyl rubber, neoprene, acrylic, LMW polyethylene, amorphous polypropylene and other polymers and with phthalate and polyester plasticizers, alkyds, hydrocarbon resins and terpene resins. Another commercial source of pentaerythritol esters of rosin is Arakawa Chemical, Inc. (Chicago, Ill.), marketed under the mark PENSEL and having acid values in ranges from 2 to 7 and 10 to 20.

Polymerized and/or Dimerized Rosins

The present invention also includes the use of polymerized and/or dimerized rosins, as briefly mentioned in the discussion of rosin esters. U.S. Pat. No. 4,339,377, entitled “Method of polymerizing rosin,” to Hollis, issued Jul. 13, 1982 ('377 Patent), discloses a catalytic method of polymerizing a rosin. The '377 Patent also states that a rosin's resistance to crystallization increases with increasing polymerized and/or dimerized rosin content. In addition, the '377 Patent recognizes that the addition of cyclic terpenes (monocyclic and dicyclic included), such as, but not limited to, d-limonene, dipentene, terpinolene, terpinene and the like, can homopolymerize and also copolymerize with the rosin components and thereby further increase crystallization resistance. The use of such cyclic terpenes is within the scope of the present invention. Of course, many of these polymerized and/or dimerized rosins are suitable for formation of rosin esters, in general, an ester rosin made from a dimerized rosin has a higher melting point than an ester rosin made from a non-dimerized rosin.

In one embodiment of the present invention, a stabilized (dimerized) tall oil rosin is used, which is sold under the mark SYLVAROS®, as SYLVAROS® PR RX Resin (Arizona Chemical Company, Panama City, Fla.). This dimerized rosin has an acid number from approximately 141 to approximately 149 (ASTM D 465) and a softening point from approximately 69° C. to approximately 78° C. (ASTM E 28-67). The dimerized rosin comprises two acid groups, which are available for further reaction, such as, but not limited to, esterification, polymerization and amidation.

Resin Amine Reactions

In general, an amine will react with an acid to form an ammonium ion. In this reaction, the unshared electron pair of the nitrogen has been used to make a N—H bond and thus is not available as a nucleophile, i.e., it is not available to react with a carbonyl compound. However, acid is important to initiate the reaction and to catalyze the removal of the water molecule later in the reaction mechanism. The fastest rate generally occurs when approximately half of the amine molecules are available to act as nucleophiles and the other half are present as the conjugate acid (ammonium salt). The ammonium ion serves as the acid catalyst since it is the strongest acid that can co-exist with the amine; any stronger acid would simply react with the amine to make more ammonium ion. When an amine and an ester react, before the alcohol leaving group portion of the ester departs, it picks up an H⁺ so that it can leave as the weak base alcohol (R′OH) rather than as the strong base alkoxide ion (R′O⁻). In general, weaker bases make better leaving groups.

In the case of a rosin ester, e.g., pentaerythritol rosin ester, reacting with an amine, the four abietic moieties may depart from the pentaerythritol and form four abietic amides, an amide forming process known as amidization. In addition, a rosin acid, e.g., abietic acid, may react with an amine to form a rosin amide, e.g., abietic amide. Of course, similar reactions are possible with polyamines wherein the formation of polyamide resins is also possible and within the scope of the present invention. U.S. Pat. No. 5,152,832, entitled “Water-soluble rosin polyamide resins,” to Hutter, et al., issued Oct. 6, 1992 ('832 Patent), discloses the formation of a resin derived from the reaction products of modified rosin and a compound containing two secondary amine groups. According to the '832 Patent, when the modified rosin consists of a rosin acid containing secondary and tertiary carboxyl groups, (e.g., fumarated (fumarized) or maleated (maleinized) rosin acid) the reaction should be carried out at a relatively low temperature (below about 235° C. (455° F.), preferably about 200° C. (392° F.)) so that reaction of the secondary carboxyls is favored over the tertiary ones. The '832 Patent also discloses the addition of polyols, including, for example, pentaerythritol, for increasing stability of resin solutions. In an embodiment of the present invention, a polyol, e.g., pentaerythritol, is released upon completion of the rosin ester/amine reaction. As mentioned previously, alcohol (including polyol) is a useful viscosity modifier or rheological property modifier. As used herein, the term “alcohol” includes polyol.

The aforementioned '632 Patent, to Schilling, discloses a condensation reaction of a polyamine with a fatty acid, rosin, fortified fatty acid, and/or fortified rosin at temperatures between 180° C. (356° F.) and 280° C. (536 ° F.). In another patent to Schilling, U.S. Pat. No. 4,810,299, entitled “Cationic aqueous bituminous emulsion-aggregate slurries,” issued Mar. 7, 1989 ('299 Patent), reaction of modified polyamines and certain polycarboxylic acids and anhydrides is disclosed. The modified polyamines are obtained by reacting suitable polyalkylene amines with a sugar containing syrup. The syrup and polyamine are heated to 120° C. (248° F.). Next, a defoamer is added and the mixture heated to 180° C. (356° F.) to 200° C. (392° F.). While maintaining this temperature, “petroleum-derived fatty acids, vegetable oils, animal fats, tall oil fatty acids, resin acids (rosin) and their reaction products with maleic anhydride, fumaric acid, acrylic acid and metacrylic acid, or their sulfonated or epoxidized derivatives” are added and the mixture heated to 200° C. (392° F.) to 250° C. (482° F.). The mixture is then cooled and a solvent added, e.g., ethylene glycol or isopropanol, to lower the viscosity of the final product. One of ordinary skill in the art would understand that the added solvent is a viscosity modifier or rheological property modifier. In preparing a bituminous emulsion, the emulsifiers of the '299 Patent are “intimately mixed under high shear in a colloid mill.” While some of the reaction mechanisms may be shared between the present invention and those disclosed in aforementioned patents (e.g., '832, '632, and '299 Patents), one of ordinary skill in the art will immediately appreciate the advantages obtained through practice of embodiments of the present invention. Of particular advantage are the embodiments of the present invention wherein a rosin ester is reacted with an amine wherein the reaction mechanism produces at least one rosin amide and at least one alcohol—or other viscosity modifier or Theological property modifier. According to this reaction mechanism, release of the alcohol helps to maintain advantageous rheological properties (e.g., viscosity). At the same time, the rosin ester material (which inherently comprises at least one rosin acid and, typically, an alcohol (or alcohols or polyols), which are joined to form at least one ester bond) is easy to handle. Of course, alcohols with relatively high boiling points and that reduce viscosity are advantageous, for example, pentaerythritol has a boiling point of approximately 275° C. (527° F.) and will not readily be removed upon heating. Proylene glycol, which is also a suitable polyol for forming rosin esters, has a boiling point of approximately 188° C. (370° F.); thus, it will also not be readily removed from mixtures heated to temperatures less approximately 188° C. (370° F.); additionally, a mixture may be heated for a period of time to a greater temperature without significant boil-off.

According to an embodiment of the present invention, a rosin and an amine are reacted at a temperature from approximately 140° F. (60° C.) to approximately 420° F. (215° C.) and more preferably at a temperature of approximately 380° F. (193° C.). The reaction time depends on a variety of factors and in most instances does not exceed approximately 6 hours. Of course, the temperature may be adjusted upwards or downwards depending on the materials used. According to this embodiment, the rosin and amine are components of, for example, a pre-mix that is subsequently added and mixed into an asphalt (bitumen) emulsion. Alternatively, an asphalt emulsion is added and mixed into the rosin and amine reaction mixture. In general, the mixture comprising rosin, amine and asphalt emulsion is mixed for a period less than approximately four hours and preferably from approximately one hour to approximately two hours.

Polymer

The present invention refers to various block polymers or block copolymers, which are used interchangeably herein and referred to as simply “Polymer” in the Examples section. Block polymers of the present invention optionally comprise linear and/or radial and/or star constituents. Suitable block polymers constituents include, for example, linear triblock copolymers (ABA), multi-armed block polymers ((AB)ₙX) and/or diblock polymers (AB), with A representing, for example, a monovinyl aromatic hydrocarbon polymer block, B representing, for example, a conjugated diene polymer block, n being an integer of 2 or higher, preferably from 2 to 6 and X representing, for example, the residue of a coupling agent. According to the present invention, the coupling agent optionally comprises any di- or polyfunctional coupling agent known in the art, for example, but not limited to, dibromoethane, silicon tetrachloride, diethyl adipate, divinylbenzene, dimethyldichlorosilane, methyl dichlorosilane and non-halogen containing coupling agents, for example, but not limited to, gamma-glycidoxypropyl-trimethoxysilane and diglycidylether of bisphenol A. Block polymers of the present invention may optionally, for example, be prepared by coupling at least two diblock polymer molecules AB together. Block polymers, which are useful as modifiers in the bituminous compositions according to the present invention, may be prepared by any method known in the art including the well known full sequential polymerization method, optionally in combination with reinitiation, and/or coupling methods. For a more detailed description of such polymers, see, e.g., U.S. Pat. No. 6,120,913, entitled “Bituminous composition for shingles,” to Kluttz, et al., issued Sep. 19, 2000 and U.S. Pat. No. 5,414,029, entitled “Aqueous bitumen-polymer emulsions, their method of preparation and their use,” to Lemoine, et al., issued May 9, 1995 ('029 Patent). The '029 Patent discloses use of organic silicon compounds for crosslinking, which is within the scope of the present invention as well.

Industrial Applicability:

The invention is further illustrated by the following non-limiting examples. The Examples given below exhibit the following approximate, non-limiting ranges:

| | | | |
|---|---|---|---|
| Cationic Emulsion | 74%-90% | Pre-Mix | 10%-26% |
| Bitumen | 58%-68% | Bitumen | 28%-60% |
| Amine | 0.75%-2% | Polymer | 30%-60% |
| Water | 28%-39% | Resin | 6%-8% |
| Acid | 0%-2% | Amine | 3%-4% |
| Nonionic Surfactant | 0%-1% | | |
| Final Product | 100% | | |
| Bitumen | 50%-66% | | |
| Amine | 1.3%-2.2% | | |
| Water | 24%-32% | | |
| Acid | 0%-1.8% | | |
| Polymer | 3%-16% | | |
| Resin | 0.6%-2.1% | | |
| Nonionic Surfactant | 0%-1% | | |

| | |
|---|---|
| Final Product | 100% |
| Bitumen | 50%-66% |
| Amine | 1.3%-2.2% |
| Water | 24%-32% |
| Acid | 0%-1.8% |
| Polymer | 3%-16% |
| Resin | 0.6%-2.1% |
| Nonionic Surfactant | 0%-1% |

The final product of the Examples are optionally made according to the following method of making:

1. Provide Resin, Polymer, and Amine and mix to form a mixture (wherein the Amine optionally comprises a Nonionic Surfactant and wherein the mixture is optionally adjusted through addition of Acid to a pH of approximately 4);

2. Provide bitumen and heat to a temperature of approximately 180° F. (82° C.);

3. Add the mixture to the heated bitumen and mix to form a “Pre-Mix”;

4. Raise temperature of Pre-Mix to approximately 380° F. (193° C.) (preferably covered);

5. Maintain temperature of Pre-Mix for approximately two hours;

6. Mix Pre-Mix using a non-shearing mixer for a period of approximately 20 minutes;

7. Cool Pre-Mix to a temperature of approximately 190° F. (83° C.);

8. Add Pre-Mix to an already prepared Cationic Emulsion; and

9. Mix Pre-Mix and Cationic Emulsion using a non-shearing mixer for a period of between approximately 20 minutes to approximately 120 minutes to form a Final Product.

A specific method of making embodiment of the present invention used the following equipment: a 55-gallon steel drum; a 2 burner, 35,000 BTU stove with a 5 gallon propane tank; an approximately 0.5″, high-density, rubber mat for covering and/or insulating the steel drum; a non-shearing mixing blade; and an approximately 0.5 HP drill for rotating or driving the mixing blade. This equipment was used as follows: Mix polymer, resin and amine to form a mixture; heat bitumen in drum using burner; add mixture to heated bitumen in durm; cover the drum with the rubber mat; raise temperature to approximately 380° F. (193° C.); maintain contents of drum at approximately 380° F. (193° C.) for a period of approximately two to three hours; mix contents using the non-shearing mixing blade and drill for a period of between approximately 20 minutes and approximately 1 hour; cool (or allow to cool) the mixed contents to a temperature of approximately 190° F. (83° C.); add a prepared Cationic Emulsion to the content in the drum (temperature of contents should be at approximately 190° F. (83° C.)); replace mat cover and heat to maintain or return to temperature of approximately 190° F. (83° C.); remove cover and mix contents using non-shearing mixing blade for a period of approximately one hour while maintaining temperature of approximately 190° F. (83° C.).

In Examples 1 through 5, given below, Acid comprises HCl (in an amount sufficient to achieve a pH of approximately 4), Polymer comprises SBS, Resin comprises pentaerythritol ester of rosin (SYLVATAC® RE 100), and Amine comprises N-tallowalkyl-1,3-diaminopropane (DUOMEEN® TD). Of course, other materials may optionally substitute for these materials as described herein. In particular, resin comprising at least one rosin group and at least one alcohol and/or at least one polyol are useful and practical. According to reactions described herein an ester bond between a “rosin acid” and an “alcohol,” upon reaction with an amine, is capable of “breaking” the ester bond and forming a rosin amide and an alcohol. In Examples 2, 3 and 5, the Amine added in the Cationic Emulsion comprises nonionic surfactant, in a mixture of approximately 50% nonionic surfactant to 50% Amine. In addition, other ranges are also suitable and within the scope of the present invention.

### EXAMPLE 1

| | | | |
|---|---|---|---|
| Cationic Emulsion | 90% | Pre-Mix | 10% |
| Bitumen | 62% | Bitumen | 60% |
| Amine | 2% | Polymer | 30% |
| Water | 34% | Resin | 6% |
| Acid | 2% | Amine | 4% |
| Final Product | 100% | | |
| Bitumen | 61.8% | | |
| Amine | 2.2% | | |
| Water | 30.6% | | |
| Acid | 1.8% | | |
| Polymer | 3% | | |
| Resin | 0.6% | | |

### EXAMPLE 2

| | | | |
|---|---|---|---|
| Cationic Emulsion | 87% | Pre-Mix | 13% |
| Bitumen | 68% | Bitumen | 50% |
| Amine | 1% | Polymer | 40% |
| Water | 28% | Resin | 7% |
| Acid | 2% | Amine | 3% |
| Nonionic Surfactant | 1% | | |
| Final Product | 100% | | |
| Bitumen | 66% | | |
| Amine | 1.3% | | |
| Water | 24.4% | | |
| Acid | 1.8% | | |
| Polymer | 5.2% | | |
| Resin | 0.9% | | |
| Nonionic Surfactant | 0.9% | | |

### EXAMPLE 3

| | | | |
|---|---|---|---|
| Cationic Emulsion | 83% | Pre-Mix | 17% |
| Bitumen | 58% | Bitumen | 45% |
| Amine | 0.75% | Polymer | 43% |
| Water | 38.5% | Resin | 8% |
| Acid | 2% | Amine | 4% |
| Nonionic Surfactant | 0.75% | | |
| Final Product | 100% | | |
| Bitumen | 56% | | |
| Amine | 1.3% | | |
| Water | 32% | | |
| Acid | 1.7% | | |
| Polymer | 7.3% | | |
| Resin | 1.4% | | |
| Nonionic Surfactant | 0.6% | | |

### EXAMPLE 4

| | | | |
|---|---|---|---|
| Cationic Emulsion | 80% | Pre-Mix | 20% |
| Bitumen | 58% | Bitumen | 34% |
| Amine | 1.5% | Polymer | 54% |
| Water | 38.5% | Resin | 8% |
| Acid | 2% | Amine | 4% |
| Final Product | 100% | | |
| Bitumen | 53% | | |
| Amine | 2% | | |
| Water | 31% | | |
| Acid | 1.6% | | |
| Polymer | 10.8% | | |
| Resin | 1.6% | | |

### EXAMPLE 5

| | | | |
|---|---|---|---|
| Cationic Emulsion | 74% | Pre-Mix | 26% |
| Bitumen | 58% | Bitumen | 60% |
| Amine | 0.8% | Polymer | 30% |
| Water | 38.5% | Resin | 6% |
| Acid | 2% | Amine | 4% |
| Nonionic Surfactant | 0.8% | | |
| Final Product | 100% | | |
| Bitumen | 50.2% | | |
| Amine | 1.6% | | |
| Water | 28.5% | | |
| Acid | 1.5% | | |
| Polymer | 15.6% | | |
| Resin | 2.1% | | |
| Nonionic Surfactant | 0.6% | | |

The following Examples (6 through 8) comprise an anionic asphalt emulsion rather than a cationic asphalt emulsion. The percentage of anionic emulsion is 74% and the percentage of pre-mix is 26% for the Examples 6 through 8; however, one of ordinary skill in the art would understand that other percentage mixes are possible and within the scope of the present invention. In Examples 6 through 8, given below, Base comprises NaOH (to adjust the pH to a value of, e.g., approximately 8), Polymer comprises SBS, Resin comprises pentaerythritol ester of rosin (SYLVATAC®) RE 100), and Amine comprises N-tallowalkyl-1,3-diaminopropane (DUOMEEN® TD). Of course, other materials may optionally substitute for these materials as described herein.

### EXAMPLE 6

| | | | |
|---|---|---|---|
| Anionic Emulsion | 74% | Pre-Mix | 26% |
| Bitumen | 62% | Bitumen | 60% |
| Tall Oil Fatty Acid | 2% | Polymer | 30% |
| Water | 34% | Resin | 6% |
| Base | 2% | Amine | 4% |
| Final Product | 100% | | |
| Bitumen | 62% | | |
| Amine | 1% | | |
| Water | 22% | | |
| Base | 2% | | |
| Polymer | 7.8% | | |
| Resin | 1.6% | | |
| Tall Oil Fatty Acid | 3.7% | | |

### EXAMPLE 7

| | | | |
|---|---|---|---|
| Anionic Emulsion | 74% | Pre-Mix | 26% |
| Bitumen | 68% | Bitumen | 60% |
| Tall Oil Fatty Acid | 5% | Polymer | 30% |
| Water | 24% | Resin | 6% |
| Base | 3% | Amine | 4% |
| Final Product | 100% | | |
| Bitumen | 66% | | |
| Amine | 1% | | |
| Water | 18% | | |
| Base | 2% | | |
| Polymer | 7.8% | | |
| Resin | 1.6% | | |
| Tall Oil Fatty Acid | 3.7% | | |

### EXAMPLE 8

| | | | |
|---|---|---|---|
| Anionic Emulsion | 74% | Pre-Mix | 26% |
| Bitumen | 63% | Bitumen | 60% |
| Tall Oil Fatty Acid | 3% | Polymer | 30% |
| Water | 29% | Resin | 6% |
| Base | 3% | Amine | 4% |
| Alkyl Sulfonate | 2% | | |
| Final Product | 100% | | |
| Bitumen | 62% | | |
| Amine | 1% | | |
| Water | 22% | | |
| Base | 2% | | |
| Polymer | 7.8% | | |
| Resin | 1.6% | | |
| Tall Oil Fatty Acid | 2% | | |
| Alkyl Sulfonate | 1.5% | | |

The following Examples (9-12) comprise compositions and a method of making the same. The general method of Example 9 through 12 comprises the following steps:

1. Heat bitumen to a temperature of between approximately 300° F. (149° C.) and 500° F. (260° C.);

2. Mix powdered polymer with a resin;

3. Add polymer/resin mixture to the heated bitumen, slowly with gentle mixing/stirring using, for example, the mixing/stirring apparatus of the present invention to form a Pre-Mix;

4. Maintain the Pre-Mix at approximately 300° F. (149° C.) to 500° F. (260° C.) for one to two hours;

5. Mix the Pre-Mix during maintenance period or near end of maintenance period using, for example, the mixer/stirrer apparatus of the invention;

6. Add the Pre-Mix to approximately thirty gallons of already prepared cationic asphalt emulsion, which is at, for example, ambient temperature; and

7. Mix the Pre-Mix and cationic emulsion, for example, using the mixing/stirring apparatus of the present invention at approximately 300 to 600 rpm for approximately ten minutes to form a Final Product.

In Examples 9 through 12, after a period of time, the polymer blended adequately into the mix. In Examples 1 through 8, which comprise an amine and a rosin ester, the polymer blended into the mixture more rapidly given the same degree of mixing. Therefore, addition of amine and/or the use of, for example, a rosin ester (or other resin that releases a viscosity modifier upon reaction (e.g., a viscosity reducer)) is advantageous for introducing polymers into an asphalt emulsion and/or asphalt solution. Thus, variations of Examples 9 through 12, within the scope of the present invention, comprise Pre-Mix comprising amine and/or resins that release a viscosity modifier upon reaction, for example, but not limited to, a rosin ester (including dimerized rosin in an ester form).

### EXAMPLE 9

### Approx. 3% SBS

In Examples 9 through 12, Bitumen comprises AC-10 bitumen from Frontier Refining, Inc. (Cheyenne, Wyo.); Polymer comprises powdered SBS (e.g., a VECTOR® (polymer from Dexco Polymers, Houston, Tex.) with a typical molecular weight of approximately 1 to approximately 1.5 million with a S/B ratio of approximately 31/69, from; Resin comprises a dimer rosin with high acid number sold under the mark SYLVAROS® PR 295, from Arizona Chemical Co. (e.g., comprising dimerized abietic acid); and Emulsion comprises a CRS-2 grade emulsion with a density of approximately 8.8 pounds per gallon.

| | |
|---|---|
| Pre-Mix | |
| Bitumen: | 82.6% |
| Resin: | 0.9% |
| Polymer: | 16.5% |
| Final Product | |
| Bitumen: | 13.6% (43 lbs) |
| Polymer: | 2.7% (8.6 lbs) |
| Resin: | 0.1% (0.45 lbs) |
| Asphalt Emulsion: | 83.5% (30 gallons @ approx. 8.8 lbs per gallon) |

### EXAMPLE 10

### Approx. 4% SBS

The same preparation method was used as described for Example 9 for the corresponding amounts of materials:

| | |
|---|---|
| Pre-Mix | |
| Bitumen: | 76.6% |
| Resin: | 1.1% |
| Polymer: | 22.3% |
| Final Product | |
| Bitumen: | 13.4% (43 lbs) |
| Polymer: | 3.9% (12.5 lbs) |
| Resin: | 0.2% (0.625 lbs) |
| Asphalt Emulsion: | 82.5% (30 gallons @ approx. 8.8 lbs per gallon) |

### EXAMPLE 11

### Approx. 5% SBS

The same preparation method was used as described for Example 9 for the corresponding amounts of materials:

| | |
|---|---|
| Pre-Mix | |
| Bitumen: | 70.3% |
| Resin: | 1.6% |
| Polymer: | 28.1% |
| Final Product | |
| Bitumen: | 13.2% (43 lbs) |
| Polymer: | 5.3% (17.2 lbs) |
| Resin: | 0.3% (0.96 lbs) |
| Asphalt Emulsion: | 81.2% (30 gallons @ approx. 8.8 lbs per gallon) |

### EXAMPLE 12

### Approx. 6% SBS

The same preparation method was used as described for Example 9 for the corresponding amounts of materials:

| | |
|---|---|
| Pre-Mix | |
| Bitumen: | 71.4% |
| Resin: | 1.4% |
| Polymer: | 27.1% |
| Final Product | |
| Bitumen: | 15% (50 lbs) |
| Polymer: | 5.7% (19 lbs) |
| Resin: | 0.3% (1 lbs) |
| Asphalt Emulsion: | 79% (30 gallons @ approx. 8.8 lbs per gallon) |

### EXAMPLE 13

The mixture of Example 9 was tested to repair a pothole. After 11 months to-date, the asphalt mixture of the present invention remains in good condition, with no evidence of shrinkage, cracking, sinking or other wear.

### EXAMPLE 14

The mixture of Example 12 was tested to repair a pothole. After 8 months, to-date, the asphalt mixture of the present invention remains in good condition, with no evidence of shrinkage, cracking, sinking or other wear.

The preceding Examples (9-14) can be repeated with similar success by substituting the generically or specifically described reactants and/or operating conditions of this invention for those used in the preceding examples. In particular, the weight percent of SBS in the final asphalt polymer emulsion can vary from approximately 2% to approximately 20%, and the corresponding weights and volume of the other constituents adjusted accordingly. Alternatively, an amine is optionally added to the Pre-Mix, as described in prior examples, and/or a resin comprising a releasable Theological property modifying group (e.g., viscosity modifier). Alternatively, a rheological property modifier (e.g., viscosity modifier) is added to the Pre-Mix during mixing and/or reaction. For example, alcohol is added in a weight percent sufficient to maintain favorable viscosity characteristics. While a logical amount of alcohol would correspond to the amount introduced through use of a rosin ester, amounts greater than and/or less than that amount are also expected to be useful. Of course, alcohol includes polyol, and a major goal is successful incorporation of polymer. Thus, one of ordinary skill in the art would be able to observe and/or analyze the process and adjust the type and/or amount of alcohol accordingly, consideration of emulsion stability also being a potential factor in determining type and/or amount added.

Of course, in yet another alternative, a resin amide may possibly be added directly, in lieu of, or in addition to, reacting resin with amine; however, ease of manufacture and cost are likely to be factors, e.g., resins and resin esters are usually more readily available and cheaper than resin amides. Again, one benefit of using, for example, rosin ester rather than rosin acid, is ease of handling, rosin ester (especially in, for example, flake form) being generally more stable and easier to handle than rosin acid (in, for example, a liquid form).

Applications

As known to one of ordinary skill in the art, asphalt has a variety of uses in paving, construction (e.g., foundation, roofing, siding, etc.), sealant, waste containment, reservoir, railroad and other industries. Various compositions of the present invention are suitable for use in these industries. In particular, cationic and/or anionic asphalt emulsions prepared according to methods of the present invention are well suited for use in repairing pavement, for example, but not limited to, pot hole repair, crack repair, and the like. In the construction industry, cold-applied asphalt compositions are useful for on-site application and/or fabrication of building materials.

Method of Applying Asphalt Emulsion

The invention additionally comprises methods to repair potholes and cracked pavement employing compositions of various embodiments of the present invention. In one embodiment the inventive method is useful for repair of a pot hole, for example, approximately three to four inches in depth. According to this embodiment, the method comprises the following steps:

1. The pothole is filled with approximately ⅜ inch washed silicious aggregate or other paving or surfacing material (for deeper pot holes, larger, washed aggregate is used wherein approximately ⅜ inch aggregate is optionally layered on top of the larger aggregate);

2. An asphalt emulsion, according to an embodiment of the present invention, is poured into the aggregate filled hole to a level approximately equal to that of the surrounding pavement;

3. A small amount of additional ⅜ inch aggregate is optionally added to the hole;

4. The filled pothole is allowed to stand undisturbed for a period of approximately twenty to thirty minutes to allow the asphalt/aggregate mixture to cure; and

5. The cured mixture is optionally compressed and/or leveled, resulting in a patch that is substantially uniform in appearance.

As to cracked pavement, for pavement cracks less than approximately one inch in width, the crack is preferably routed with a commercial pavement router to at least one inch in width, cleared of loose sand or gravel, and filled with approximately ⅛ to ¼ inch washed silicious aggregate. The fill steps are repeated as in the case of repairing the pothole, above.

Mixer for Making Pre-mix and Emulsion

The present invention also comprises a mixer/stirrer/blender apparatus comprising a shaft, a plate or blade with at least one opening in the blade. In one embodiment, the blender comprises a plurality of plates (for example, but not limited to, approximately three plates), and a plurality of openings in at least two of the plates (flow-through plates). In an embodiment comprising three plates, one of the plates serves as a central plate comprising an aperture for placement and/or fixation of a shaft while the other two “flow-through” plates each comprise an aperture for placement and/or fixation of a shaft together with surrounding openings. All of the plates optionally comprise a circular diameter. For certain applications (e.g. use in a 55-gallon drum), the plates optionally comprise an approximately five-inch radius.

The openings in the flow-through plates optionally comprise circular diameters. According to one embodiment, each flow-through plate comprises approximately four openings. According to this embodiment, each opening is spaced plus or minus ninety-degrees from neighboring openings with respect to a center of the plate. The centers of the openings in the flow-through plates are located at a distance of approximately 70% of the plate radius, assuming a circular diameter. In this embodiment, the radii of the circular openings are approximately 20% of the plate radius. Spacers are optionally positioned on the shaft, interposed between plates. Spacers are, for example, approximately ⅛ inch thick. The configuration of this particular embodiment minimizes shear of the mixture being processed.

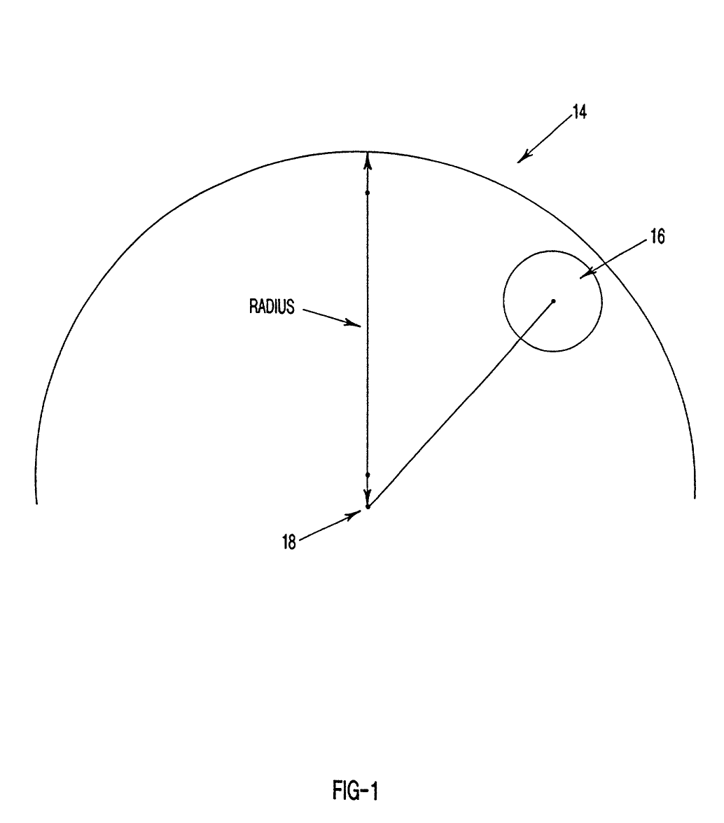

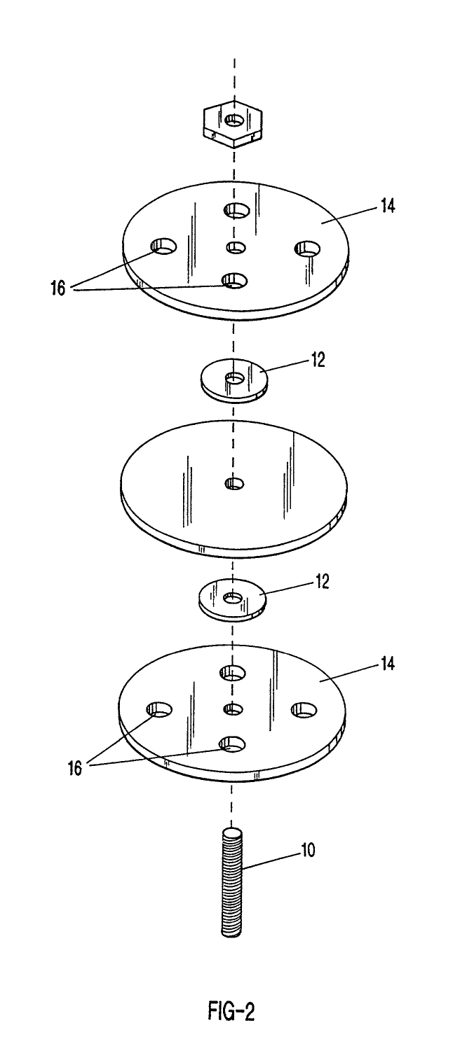

Referring to FIGS. 1 and 2, an embodiment of the mechanical stirrer/mixer/blender for use in mixing pre-mixes, emulsions, asphalt and/or combinations thereof is shown. This particular embodiment facilitates the mixing of various components, more specifically, the mixing of polymer into an asphalt. As shown in FIGS. 1 and 2, the stirrer comprises a shaft 10, a plurality of stirrer blades 14, and a plurality of spacers 12. The shaft 10 may be disposed in any container (e.g. a 55-gallon drum) for conducting the mixing on site. A motor is suitable for driving the shaft 10. According to one embodiment, a variable speed motor is used, which is capable of rotating the shaft up to 2,500 rpm.

In one embodiment, the stirrer comprises three plates. The plates are approximately ¼ inch thick and disposed on top of each other with ⅛ inch washers or spacers. A useful material of construction of the plates is aluminum, but other materials known in the art may be utilized. The plates optionally comprise a radius of approximately five inches. The plates are attached to one end of the shaft 10. Each outer plate 14 comprises circular openings 16 (e.g. four openings), ninety degrees from one another, that are optionally centered 3½ inches from the center of the plate 18. In this embodiment, the openings comprise diameters of approximately 2 inches.

Although circular openings are shown in the drawings, oval openings could be utilized. The purpose of circular or oval openings is to avoid shear. When the liquid enters the hole, it acts as a pump and pumps the liquid over the surface of the blade. An opening of sharp edges (e.g. square openings) may cause increased shear. Radial velocity is used to achieve the pumping and stirring of the mixture. Likewise the plates may have more or less than four openings.

Although the invention has been described in detail with particular reference to these preferred embodiments, other embodiments can achieve the same results. Variations and modifications of the present invention will be obvious to those skilled in the art and it is intended to cover in the appended claims all such modifications and equivalents. The entire disclosures of all references, applications, patents, and publications cited above are hereby incorporated by reference.

What is claimed is:

1. A composition comprising bitumen and products obtained by reacting a resin with an amine.

2. The composition of claim 1 further comprising a polymer.

3. The composition of claim 2 wherein polymer comprises at least approximately 3% of the composition by weight.

4. The composition of claim 2 wherein said polymer comprises styrene.

5. The composition of claim 4 wherein said polymer comprises SBS.

6. The composition of claim 1 wherein said resin comprises pentaerythritol ester of rosin.

7. The composition of claim 1 wherein said products comprise an amide.

8. The composition of claim 1 wherein said products comprise an alcohol.

9. The composition of claim 8 wherein said alcohol comprises a polyol.

10. A composition comprising bitumen, polymer, and products obtained by reacting a rosin ester with an amine, wherein said products comprise an alcohol and an amide.

11. The composition of claim 10 wherein said composition is an emulsion.

12. A method of incorporating polymer into a bitumen emulsion comprising the steps of:
combining bitumen, polymer, resin and amine to form a pre-mix;
heating the pre-mix to a temperature sufficient to react the resin and the amine to form reaction products; and
mixing the reacted pre-mix with a bitumen emulsion.

13. The method of claim 12 wherein the resin comprises a rosin ester.

14. The method of claim 13 wherein the rosin ester comprises a pentaerythritol ester of rosin.

15. The method of claim 12 wherein the polymer comprises styrene.

16. The method of claim 15 wherein the polymer comprises SBS.

17. The method of claim 12 wherein the reaction products comprise an alcohol.

18. The method of claim 17 wherein the alcohol comprises a polyol.

19. The method of claim 12 wherein the bitumen emulsion comprises an emulsion selected from the group consisting of cationic, nonionic, and anionic emulsions.

20. The method of claim 12 wherein the mixing step comprises low shear mixing.

21. A method of reducing the viscosity of a composition comprising bitumen and polymer, the method comprising the steps of:
adding a resin and an amine to the composition; and
reacting the resin and the amine to form reaction products, the reaction products comprising a viscosity reducer.

22. The method of claim 21 wherein the viscosity reducer comprises an alcohol.

23. The method of claim 21 wherein the viscosity reducer comprises a polyol.

24. A composition comprising bitumen, polymer and products obtained by reacting a resin with an amine, wherein low shear mixing of said bitumen, polymer and products forms a stable bitumen emulsion.

25. The composition of claim 24 wherein said polymer comprises styrene.

26. The composition of claim 25 wherein said polymer comprises SBS.

27. The composition of claim 24 wherein said resin comprises a rosin ester.

28. The composition of claim 27 wherein said rosin ester comprises a pentaerythritol ester of rosin.

29. The composition of claim 23 wherein said products comprise an alcohol.

30. The composition of claim 29 wherein said alcohol comprises a polyol.
